(19) United States
(12) Patent Application Publication
(10) Pub. No.: US 2025/0108923 A1
(43) Pub. Date: Apr. 3, 2025

(54) ADDITIVELY MANUFACTURED LOUVERED AIRCRAFT VENTS

(71) Applicant: Textron Aviation Inc., Wichita, KS (US)

(72) Inventors: Dhagash S. SHAH, Wichita, KS (US); Bryan C. HINSON, Andover, KS (US); Joshua Ross HUSTON, Douglass, KS (US); Vivekanandhan SHANMUGA SUNDARAM, Wichita, KS (US)

(21) Appl. No.: 18/476,467

(22) Filed: Sep. 28, 2023

(51) Int. Cl. B64D 13/00; B33Y 80/00

(52) U.S. Cl. CPC B64D 13/00; B33Y 80/00; B64D 2013/003

(57) ABSTRACT

Additively manufactured aircraft vent structures are provided with a one-piece frame which includes a substantially planar face plate defining a longitudinally elongate vent opening and a series of fixed-position vanes unitarily joined to the planar face plate which extend latitudinally across the vent opening. Each of the vanes may be curvilinear and provided such that unidirectional venting is established or may be in a V-shaped configuration of vane pairs such that multidirectional venting is established. Alternatively or additionally, the vanes may have a widthwise dimension between leading and trailing edges thereof such that the trailing edges of each vane terminally extends at least to a latitudinal plane defined by a leading edge of an immediately adjacent one of the vanes.

### FIELD

The embodiments disclosed herein relate generally to aircraft vent structures which allow air to be vented to the ambient environment externally of the aircraft.

### BACKGROUND

Aircraft include various on-board systems that employ louvered vent structures to exhaust air into the ambient environment, e.g., cabin environmental control systems which exhaust pressurized cabin air. The performance of louvered exhaust vents is however dependent on the fixed position tilt of the individual vanes (louvers) along with the number of vanes (vane count) associated with the vent. However, the conventional manufacturing techniques for forming louvered vents (e.g., machining and/or milling of aluminum stock) is a limiting factor on improving the geometries and vane count of louvered aircraft vents.

While conventional manufacturing techniques may be adequate for manufacturing louvered aircraft vent structures, the aeronautical industry continually strives to improve performance characteristics of all aircraft components, including louvered vent structures. It is towards providing such a need that the embodiments disclosed herein are directed.

### SUMMARY

In general the embodiments disclosed herein are directed toward additively manufactured one-piece aircraft vent structures. According to some embodiments, one-piece aircraft vent structures are provided with a unitary (one-piece) frame which includes a substantially planar face plate defining a longitudinally elongate vent opening and a series of fixed-position vanes unitarily joined to the planar face plate which extend latitudinally across the vent opening.

Each of the vanes may be curvilinear and provided such that unidirectional venting is established. Alternatively, the vanes may be provided in a V-shaped configuration of vane pairs such that multidirectional venting is established. Alternatively or additionally, the vanes may have a widthwise dimension between leading and trailing edges thereof such that the trailing edges of each vane terminally extends at least to a latitudinal plane defined by a leading edge of an immediately adjacent one of the vanes.

These and other aspects and advantages of the present invention will become more clear after careful consideration is given to the following detailed description of the preferred exemplary embodiments thereof.

### BRIEF DESCRIPTION OF ACCOMPANYING DRAWINGS

The disclosed embodiments of the present invention will be better and more completely understood by referring to the following detailed description of exemplary non-limiting illustrative embodiments in conjunction with the drawings of which:

FIG. 1 is a top perspective view of an additively manufactured unidirectional vent structure with curvilinear vanes in accordance with an embodiment of the present invention;

FIG. 2 is bottom perspective view of the louvered vent structure shown in FIG. 1;

FIG. 3 is a cross-sectional elevational view of the vent structure shown in FIG. 1 as taken along lines 3-3 therein;

FIG. 4 is a top perspective view of an additively manufactured multidirectional vent structure with curvilinear vanes in accordance with another embodiment in accordance with the present invention;

FIG. 5 is a bottom perspective view of the louvered vent structure shown in FIG. 4;

FIG. 6 is a cross-sectional elevational view of the vent structure shown in FIG. 4 as taken along lines 6-6 therein;

FIG. 7 is a top perspective view of an additively manufactured vent structure with a gapless vane arrangement in accordance with another embodiment in accordance with the present invention;

FIG. 8 is a bottom perspective view of the louvered vent structure shown in FIG. 7;

FIG. 9 is a cross-sectional elevational view of the vent structure shown in FIG. 7 as taken along lines 9-9 therein; and

FIG. 10 is an enlarged cross-sectional view of a representative vane arrangement in the vent structure shown in FIG. 9.

### DETAILED DESCRIPTION OF EMBODIMENTS

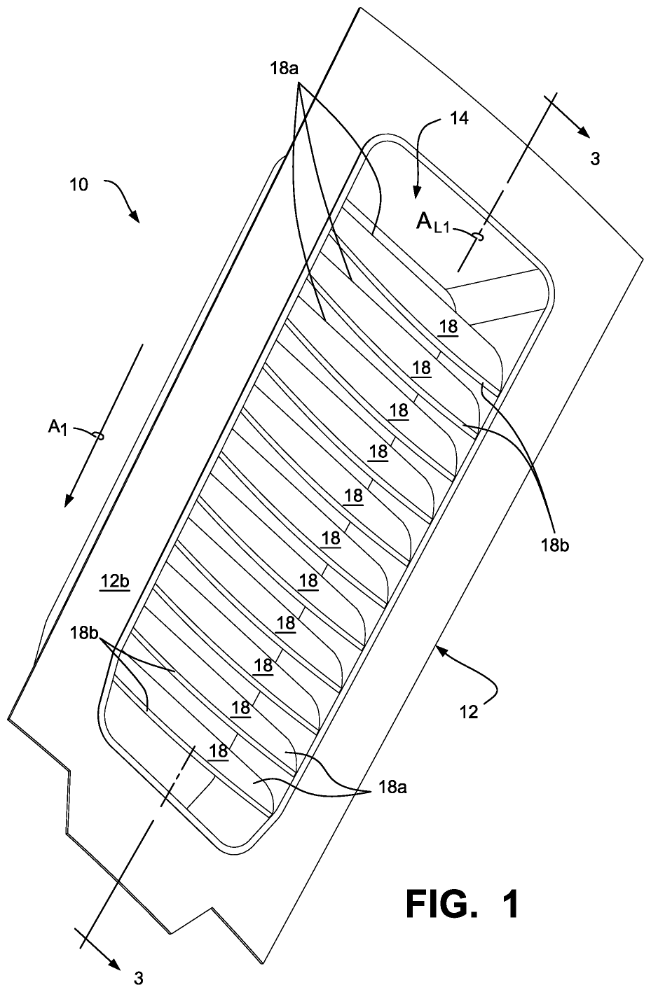

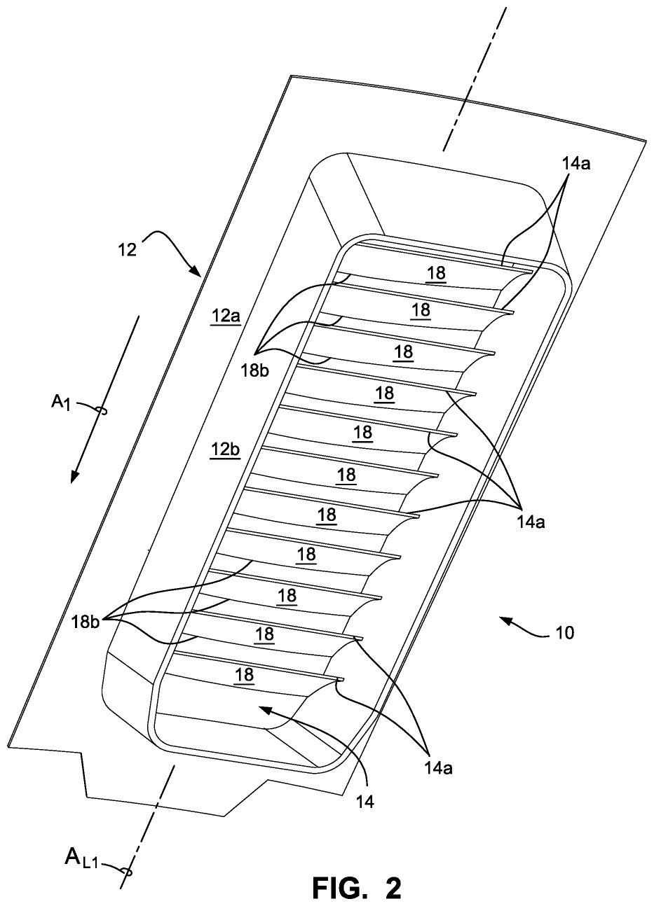

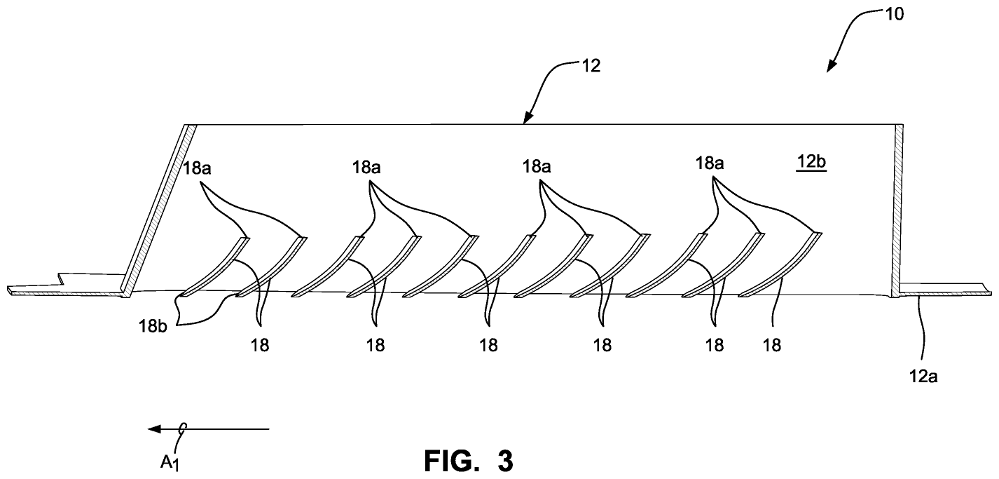

Accompanying FIGS. 1-3 show an embodiment of a one-piece (unitary) aircraft vent structure 10 formed by additive manufacturing (ALM) process (sometimes referenced as a 3D manufacturing or printing process). The ALM process is typically practiced by laser sintering on a layer-by-layer basis a metallic powder with the aid of a 3D computer model. That is, successive relatively thin layers of metallic powder may be laser sintered based on corresponding slices of the computer-aided 3D model. Once all of the layers have been laser sintered, a complete one-piece metal aircraft vent structure is formed. The fabrication of various components using ALM processing techniques is further described in U.S. Pat. Nos. 9,388,078, 10,065,240, 10,392,131, 10,589,878 and 11,542,041, the entire contents of which are expressly incorporated hereinto by reference.

The vent structure 10 shown in FIGS. 1-3 includes a one-piece frame 12 comprised of a substantially planar face plate 12a which defines a longitudinally elongate vent opening 14. A mounting flange 12b bounding the vent opening 14 is unitarily joined to a rear surface of the face plate 12a and extends rearwardly therefrom to allow the vent structure 10 to be attached to an associated duct (not shown) of the aircraft. A series of fixed-position vanes (or louvers) 18 are formed as one-piece structures with the frame 12 and extend latitudinally across the vent opening 14 so as to unidirectionally vent air from the vent structure 10 in an aftward direction which is substantially parallel to the elongate axis AL of the vent structure 10 (see arrow A1 in FIGS. 1-3).

Each of the vanes 18 is convexly curved between the trailing and leading edges 18a, 18b thereof, respectively. The convex curvilinear cross-sectional geometry of the vanes 18 may be uniformly or non-uniformly curved, i.e., the vanes 18 may each have a symmetrical or nonsymmetrical radius of curvature. For example, each of the vanes 18 may have a uniform radius of curvature between the trailing and leading edges 18a, 18b thereof. Alternatively, each of the vanes 18 may have a non-symmetrical curvature whereby the vanes 18 have a smaller radius of curvature near the leading edge 18a and transitions to a larger radius of curvature near the trailing edge 18b thereof and vice versa. Suffice it to say, the specific curvilinear cross-sectional geometry will be determined by the design flow characteristics of the vent structure 10 and its placement on the exterior skin of the aircraft so as to minimize drag and/or airflow disruption.

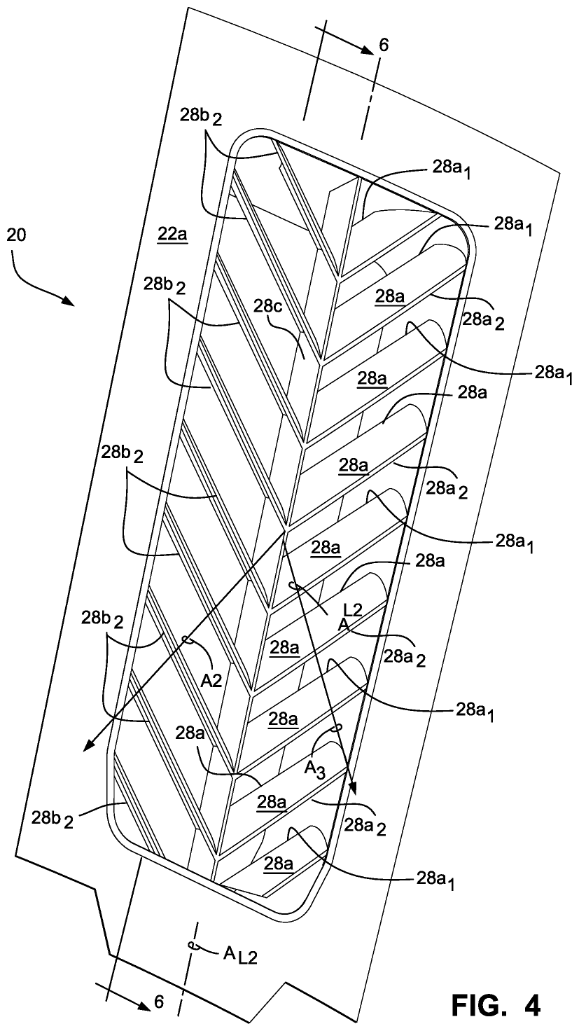

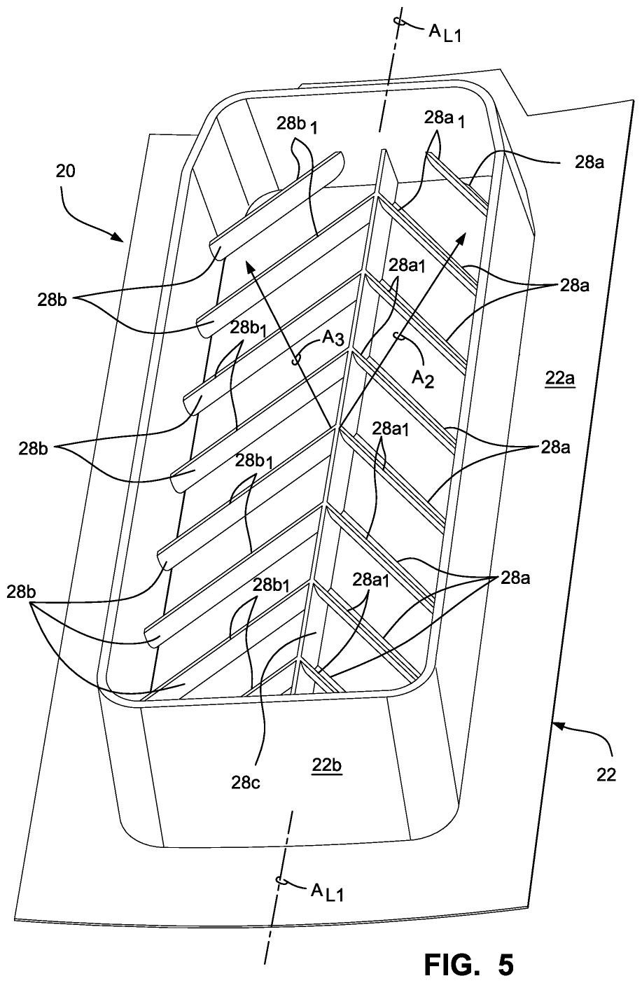

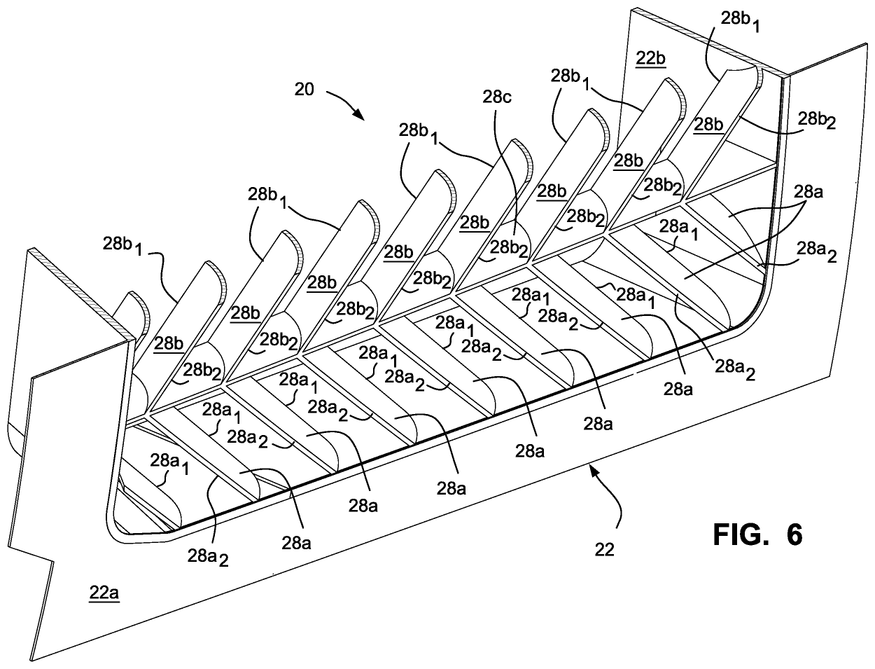

Air venting distribution efficiencies may be further improved by the one-piece multidirectional vent structure 20 embodiment as shown in FIGS. 4-6. In this regard, the vent structure 20 may similarly be formed by ALM processing so as to include a one-piece frame 22 comprised of a substantially planar face plate 22a which defines a longitudinally elongate vent opening 24. A mounting flange 22b bounding the vent opening 24 is unitarily joined to a rear surface of the face plate 22a and extends rearwardly therefrom to allow the vent structure 20 to be attached to an associated duct (not shown) of the aircraft.

A series of fixed-position pairs of vanes (or louvers) 28a and 28b are formed as one-piece structures with the lateral sides of the frame 12 and extend convergingly therefrom to be unitarily joined with a central planar rib 28c extending longitudinally between the forward and aft sides of the frame 12. The pairs of vanes 28a, 28b thereby form a V-shaped configuration that divergently vents air from the vent structure 20 relative to the longitudinal rib 28c in a generally aftward direction parallel to the longitudinal axis AL2 of the vent structure 20 (see arrows A2 and A3 in FIGS. 4-6). Such bidirectional divergence of the vented air relative to the longitudinally extending planar rib 28c may further result in further drag reduction as compared to the unidirectional venting of air as described previously.

Each of the vanes 28a, 28b may be convexly curved between the trailing and leading edges 28a1, 28a2 and 28b1, 28b2 thereof, respectively. The convex curvilinear cross-sectional geometry of the vane pairs 28a, 28b may be symmetrically or asymmetrically curved, i.e., the vanes 18 may each have a symmetrical or asymmetrical radius of curvature between the trailing and leading edges 28a1, 28a2 and 28b1, 28b2 thereof, respectively. For example, each of the vanes 28 may have a uniform radius of curvature between the trailing and leading edges trailing and leading edges 28a1, 28a2 and 28b1, 28b2 thereof, respectively. Alternatively, each of the vanes 28a, 28b may have a non-uniform curvature whereby the vanes 28a, 28b have a smaller radius of curvature near the leading edges 28a1, 28b1 which transitions to a larger radius of curvature near the trailing edge 28a2, 28b2 thereof and vice versa. Again, the specific curvilinear cross-sectional geometry will be determined by the design flow characteristics of the vent structure 20 and its placement on the exterior skin of the aircraft so as to minimize drag and/or airflow disruption.

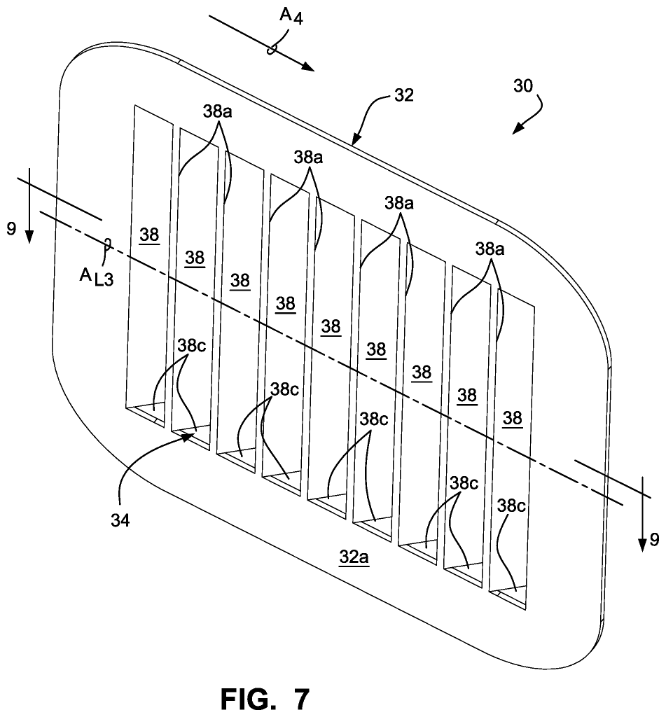

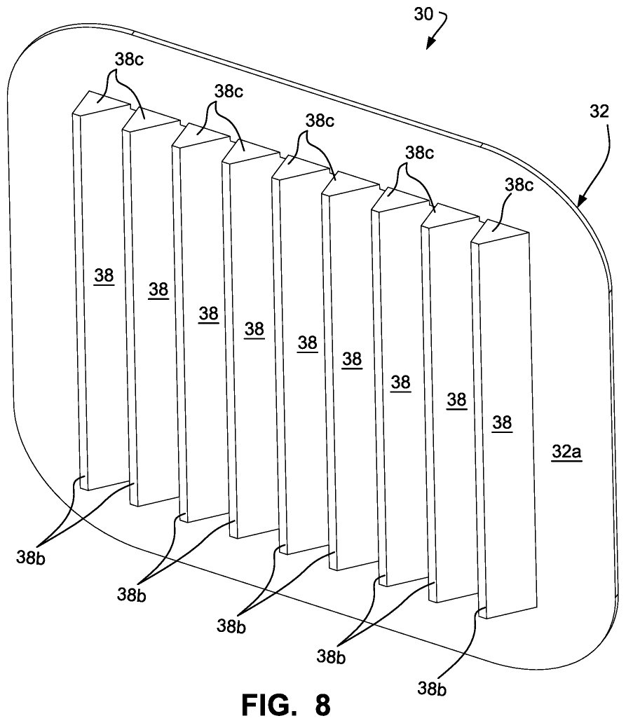

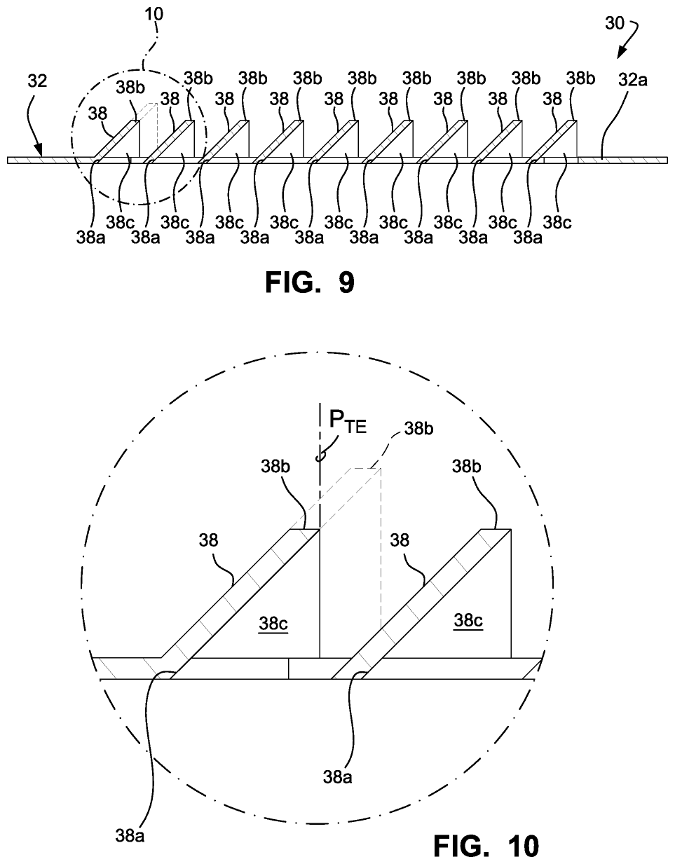

The ALM process can also be employed to fabricate a one-piece (unitary) vent structure 30 as shown in FIGS. 7-9. The vent structure 30 includes a one-piece frame 32 having a substantially planar face plate 32a that defines a longitudinally elongate central opening 34. A series of fixed position planar vanes (or louvers) 38 extend latitudinally across the vent opening 34 (i.e., transverse to the longitudinal axis AL3). The planar vanes 38 are angled so as to unidirectionally vent air from the vent structure 30 in an aftward direction substantially parallel to the longitudinal axis AL3 (see arrow A3 in FIG. 7).

Each of the vanes 38 includes a trailing edge 38a that extends between and is unitarily joined to opposed generally triangular side supports 38c. The leading edge 38b of the vanes 38 extends latitudinally across the opening 34 and is unitarily coplanar with the face plate 32a. As is perhaps better depicted in FIG. 10, each of the vanes 38 has a widthwise dimension between the leading and trailing edges 38a, 38b, respectively, thereof such that the trailing edges 38b of the vanes 38 terminally extend at least to a latitudinal plane PTE defined by a leading edge 38a of an immediately adjacent one of the vanes 38 (i.e., the trailing edges 38b of the vanes terminate within the latitudinal plane PTE). In some embodiments, the trailing edges 38b of the vanes 38 will extend beyond the latitudinal plane PTE defined by a leading edge 38a of an immediately adjacent one of the vanes 38 (i.e., as shown by dashed lines in FIG. 10). Such dimensioning of the vanes 38 will therefore provide a vent structure that has no visible dimensional gap between the trailing and leading edges 38a, 38b of respective adjacent vanes 38 when viewed in plan. Such a structural arrangement, which is believed to only be available by forming the vent structure 30 by ALM processing techniques, thereby improves efficiencies of the vent structure 30 as well as to minimize (if not prevent entirely) ingress of fluids.

While reference has been made to particular embodiments of the invention, various modifications within the skill of those in the art may be envisioned. Therefore, it is to be understood that the invention is not to be limited to the disclosed embodiments, but on the contrary, is intended to cover various modifications and equivalent arrangements included within the spirit and scope thereof.

What is claimed is:

1. An additively manufactured aircraft vent structure comprising:
a one-piece frame comprising a substantially planar face plate which defines a longitudinally elongate vent opening; and
a series of fixed-position curvilinear vanes unitarily joined to the planar face plate which extend latitudinally across the vent opening.

2. The vent structure according to claim 1, wherein each of the vanes has a convex curvilinear cross-sectional geometry.

3. The vent structure according to claim 1, wherein each of the vanes is uniformly curvilinear.

4. The vent structure according to claim 1, wherein each of the vanes is non-uniformly curvilinear.

5. The vent structure according to claim 1, wherein the frame includes a mounting flange bounding the vent opening and unitarily joined to and extending from a rear surface of the face plate.

6. The vent structure according to claim 1, wherein
the frame includes a longitudinally extending central rib, and wherein
the vanes include curvilinear vane pairs that unitarily extend between the central rib and an adjacent portion of the frame.

7. The vent structure according to claim 6, wherein the vane pairs form a V-shaped series of curvilinear vanes which allow multidirectional venting of air.

8. An additively manufactured aircraft vent structure comprising:
a one-piece frame comprising a substantially planar face plate which defines a longitudinally elongate vent opening;
a central rib element longitudinally extending within the vent opening between forward and aft portions of the frame; and
a series of fixed-position V-shaped pairs of curvilinear vanes each unitarily joined to the central rib element and a corresponding lateral region of the frame.

9. The vent structure according to claim 8, wherein each of the vanes has a convex curvilinear cross-sectional geometry.

10. The vent structure according to claim 8, wherein each of the vanes is uniformly curvilinear.

11. The vent structure according to claim 8, wherein each of the vanes is non-uniformly curvilinear.

12. The vent structure according to claim 8, wherein the frame includes a mounting flange bounding the vent opening and unitarily joined to and extending from a rear surface of the face plate.

13. A vent structure comprising:
a one-piece frame comprising a substantially planar face plate which defines a longitudinally elongate vent opening; and
a series of fixed-position angularly oriented planar vanes unitarily joined to the planar face plate which extend latitudinally across the vent opening, wherein
each of the vanes has a widthwise dimension between leading and trailing edges thereof such that the trailing edges of each vane extends at least to a latitudinal plane defined by a leading edge of an immediately adjacent one of the vanes.

14. The vent structure according to claim 13, wherein the widthwise dimension of each of the vanes is such that the trailing edges of each vane extends beyond the latitudinal plane defined by the leading edge of an immediately adjacent one of the vanes.

15. The vent structure according to claim 13, wherein each of the vanes extends latitudinally across the vent opening and are unitarily joined to opposed side supports of the frame.

16. The vent structure according to claim 15, wherein the side supports are generally triangular.
